(19) United States
(12) Patent Application Publication
(10) Pub. No.: US 2007/0203629 A1
(43) Pub. Date: Aug. 30, 2007

(54) Vehicle Axle System, Torque Tube, Vehicle Axle, And Vehicle

(75) Inventors: Nicolai Tarasinski, Frankenthal (DE); Joachim Sobotzik, Lambsheim (DE); Marco Reinards, Bleialf (DE); Bernd Kneer, Viernheim (DE)

Correspondence Address: DEERE & COMPANY, ONE JOHN DEERE PLACE, MOLINE, IL, 61265, US

(73) Assignee: DEERE & COMPANY, Moline, IL (US)

(21) Appl. No.: 10/574,128

(22) PCT Filed: Oct. 28, 2004
(86) PCT No.: PCT/EP04/12209

§ 371 Date: Feb. 8, 2007

(30) Foreign Application Priority Data
Oct. 31, 2003 (DE) 103 51 308.6

(51) Int. Cl. G06F 19/00

(52) U.S. Cl. 701/50

(57) ABSTRACT

The invention relates to a vehicle axle system for agricultural or industrial utility vehicles, comprising a movably, preferably oscillatingly, mounted vehicle axle (30) to which at least two wheels (28) can be rotatably fixed. A torque tube (38) is provided, one end of which can be connected to a vehicle (10) frame (14) while the other end thereof can be joined to the vehicle axle (30) so as to support the axle suspension. An electric drive (32) by means of which at least one wheel (28) that is fixed to the vehicle axle (30) can be driven is disposed on the vehicle axle (30). The aim of the invention is to supply the electric drives (32) with electrical power via supply lines which will not be damaged in normal conditions. The inventive vehicle axle system is characterized in that electrical components (40, 42) for the electric drive (32) are provided on, preferably in, the torque tube (38).

The invention relates to a vehicle axle system for an agricultural or industrial utility vehicle. The vehicle axle system has a moving—preferably oscillating—supported vehicle axle, wherein at least two wheels can be attached to the vehicle axle so that they can rotate. A torque tube is provided, which can be connected on one end to a vehicle frame and on the other end to the vehicle axle for supporting the axle suspension. On the vehicle axle there is at least one electric drive, with which at least one wheel attached to the vehicle axle can be driven. Furthermore, the present invention relates to a torque tube, which can be connected on one end to a vehicle frame and on the other end to a vehicle axle for supporting the axle suspension. In addition, the present invention relates to a vehicle axle, which can be installed on a vehicle so that it can move, and is preferably supported so that it can oscillate, and to which at least two wheels can be attached so that they can rotate. The present invention also relates to a vehicle, especially an agricultural or industrial utility vehicle.

Vehicle axle systems of the type named above have been known for a long time from the state of the art. For example, from EP 0 913 280 A1, a vehicle axle system is known, in which the front axle is attached to a torque tube for supporting the axle suspension. One end of the torque tube is connected to the vehicle frame via a ball-and-socket joint. The other end of the torque tube is fixed rigidly to the front axle. The front axle is supported so it can oscillate. The torque tube is used in the commercial vehicle known from EP 0 193 280 A1—which is embodied in the form of a farming tractor—for supporting the front axle in the vehicle longitudinal direction. Very generally, the torque tube is also called a tie member or torque connecting rod. The torque tube typically holds a drive shaft, which transfers at least part of the torque generated by an internal combustion engine to the wheels allocated to the vehicle axle—optionally via a differential transmission. Thus, the torque tube is used on one hand for supporting the suspension of a vehicle axle and on the other hand for protecting a drive shaft running inside this axle.

Furthermore, from DE 196 23 738 A1, a commercial vehicle is known, which can have a front axle with electric single wheel drives. Here, the wheels of the front axle are driven via a cardan shaft by an internal combustion engine and/or by the electric drive via a pick-off gear, wherein the drive power of the cardan shaft and that of the electric drive can be delivered to the wheel via a pick-off gear. In this way, a continuously variable adaptation of the rpm values of the individual wheels of the front axle is possible, which allows this vehicle to be used for multiple purposes.

Now the electric drives on the vehicle axle could be connected to a generator in the vehicle through flexible electric line connections. Disadvantages here are that such flexible electric lines can be damaged, in particular by martens, during the use of the commercial vehicle or in the power-off state.

Therefore, the present invention is based on the problem of providing and improving a vehicle axle system, a vehicle axle, a torque tube, and a vehicle of the type named above, through which the previously mentioned problems can be solved. In particular, the electric drives should be powered with electric current, so that the relevant power lines cannot be damaged under normal conditions.

The problem is solved according to the invention by the teaching of Claim 1. Other advantageous configurations and improvements of the invention result from the subordinate claims.

According to the invention, a vehicle axle system of the type named above is characterized in that electric components for the electric drive are provided on the torque tube.

According to the invention, first it has been recognized that especially electric power lines can be guided from a generator or power-supply system in the vehicle via the torque tube to the vehicle axle, especially running inside the torque tube, so that the electric lines are protected from external influences from the vehicle to the moving vehicle axle. Thus, the electric power lines must not be laid, for example, along a hydraulic cylinder, which connects a vehicle frame to the moving vehicle axle system, where the electric power lines would not be protected from external influences. Therefore, the electric components for the electric drive are preferably arranged in the torque tube. In this respect, in addition to the existing functions—supporting the axle suspension and protecting an optional mechanical drive shaft—the torque tube takes on another function, namely the guidance and protection of electric connecting lines or very generally the protection of electric components.

Now, the torque tube could have an essentially circular, oval, or polygonal cross section. Along its longitudinal direction, the torque tube could be conical, wherein the part of the torque tube facing the vehicle axle system could have a larger cross section than the part facing the commercial vehicle frame. Optionally, an elongated indentation could be provided in the torque tube, in which electric power lines are arranged. In this case, the corresponding electric components are arranged on the outer region of the torque tube—but protected by the indentation. Preferably, the torque tube can be assembled from several parts and embodied, in particular, modular. Thus, a part of the torque tube could have an essentially U-shaped cross section, on which the other part of the torque tube can be mounted, which could have an essentially flat shape. Such a configuration of the torque tube enables simple assembly of the electric components arranged inside the tube. As long as the torque tube is also formed in a modular way, it can be assembled from individual modules.

In a preferred embodiment, the electric components in the torque tube could have at least one power electronics component. With such a power electronics component, for example, the magnitude of the electric power delivered to the electric drive could be controlled.

Alternatively or additionally to the arrangement of a power electronics component in the torque tube, at least one power electronics component could be arranged on the vehicle axle, wherein this power electronics component could fulfill a comparable function.

In a similarly preferred embodiment, the electric components on the torque tube could have a frequency converter. In principle, the electric current for the electric drives would be generated with the help of a generator. Typically, such a generator is driven by the internal combustion engine of the commercial vehicle. However, because the internal combustion engine has a variable rpm depending on the driving situation of the commercial vehicle, the electric current generated by the generator has a variable frequency. Such a frequency converter could be used for converting the electric alternating current of variable frequency into an electric alternating current of a given, essentially constant frequency. With the frequency converter, the electric alternating current of variable frequency generated by the electric generator could first be converted into direct current and then into alternating current of a given frequency. The electric drive, which is preferably embodied as an asynchronous motor, could then be driven with this alternating current.

In a preferred embodiment, the electric components in the torque tube could have a braking resistance. Such braking resistance could be used for braking with the wheels of the vehicle axle system, namely when the electric drives in the vehicle axle system are operated in generator mode. As soon as the electric drives are operated in generator mode, these generate electric current, which could be fed, for example, to the braking resistance or to another electric load. In this way, the electric drives generate a braking torque, which could be used, for example, when the commercial vehicle is driving downhill with long periods of braking. The braking resistance could be configured, for example, in the form of a heating coil, with which vehicle components, for example, the transmission oil circuit, are heated optionally by means of corresponding lines containing heat-transferring fluid. Very generally, the electric current generated by the electric drive that can be operated in a generator mode can be converted into mechanical and/or thermodynamic energy and used or stored at another location in the commercial vehicle.

In an especially preferred embodiment, the electric components in the torque tube have a controller. With the controller, the electric drive, optionally the power electronics component, the frequency converter, and/or the braking resistance can be controlled or regulated.

In particular, when the vehicle axle system according to the invention is used for a front axle of a commercial vehicle, the vehicle axle could have a steering-type axle. In this case, it would be useful to drive the wheels of the rear axle purely mechanically by an internal combustion engine allocated to the commercial vehicle and to drive the wheels of the steering-type axle purely electrically. In this way, the wheels of each axle half of the steering-type axle can be controlled in an especially advantageous way with rpm values independent of each other, so that, for example, power steering can be realized, however, without providing a mechanically complicated gear train between the wheels of each axle half.

In an especially preferred way, at least one electric interface is provided on the torque tube. With this interface, at least one electric line provided on the vehicle frame and/or on the vehicle axle can be connected to at least one electric line, which is arranged on the torque tube. In this way, the assembly of the commercial vehicle can be simplified in an especially advantageous way, namely, a cable tree does not have to be pulled through the torque tube or laid in the torque tube. Instead, only the connections of the electric interface are to be established, wherein an electric interface could have a plug system, which is preferably embodied so that it can be screwed on and in this way would be secured against unintentional detachment.

For further simplification of the commercial vehicle assembly, but also for simpler retrofitting of already existing commercial vehicles, the electric components in the torque tube could be preassembled in a carrier structure. In this way, the electric components added to the carrier structure would form one module, which can be mounted on or in the torque tube. The carrier structure itself could include, in turn, components of a cooling system, with which the electric components in the torque tube could be cooled.

In an electric drive system for a commercial vehicle, the cooling of the electric components can represent an important aspect of the vehicle design. From this background, the surface and/or the walls of the vehicle axle and/or the torque tube could be configured so that cooling of the electric components is possible. This could be achieved in detail in that the surface and/or the walls of the vehicle axle and/or the torque tube have cooling fins and/or at least one channel. Preferably, the channel has a meander-like arrangement and can carry, in particular, a flow of coolant. With the cooling fins on the torque tube or on the vehicle axle, air cooling of the electric components can be performed. With a channel carrying a flow of coolant, for example, water cooling could be realized.

The problem named above in terms of a torque tube is solved by the features of Claim 13. Accordingly, a torque tube for supporting axle suspension is connected on one end to a vehicle frame and on the other end to a vehicle axle. The torque tube according to the invention is characterized in that the torque tube can be attached to a vehicle axle system according to one of Claims 1 to 12.

The problem named above in terms of a vehicle axle is solved by the features of Claim 14. Accordingly, a vehicle axle can be installed on a vehicle so that it can move and is supported preferably so that it can oscillate. At least two wheels are attached to the vehicle axle so that they can rotate. The vehicle axle according to the invention is characterized in that it can be adapted to a vehicle axle system according to one of Claims 1 to 12.

The problem named above in terms of a vehicle and especially an agricultural or industrial utility vehicle is solved by the features of Claim 15. Accordingly, the vehicle according to the invention is characterized by a vehicle axle system according to one of Claims 1 to 12.

To avoid repetition, reference is made to the preceding portion of the description.

Now, there are various possibilities for embodying and improving the teaching the present invention in an advantageous way. Thereto, reference is made, on one hand, to the claims dependent on Claim 1 and, on the other hand, to the following explanation of the preferred embodiments of the invention with reference to the drawing. In connection with the explanation of the preferred embodiments of the invention with reference to the drawing, generally preferred configurations and improvements of the teaching will also be explained. Shown in the drawings in a schematic diagram are

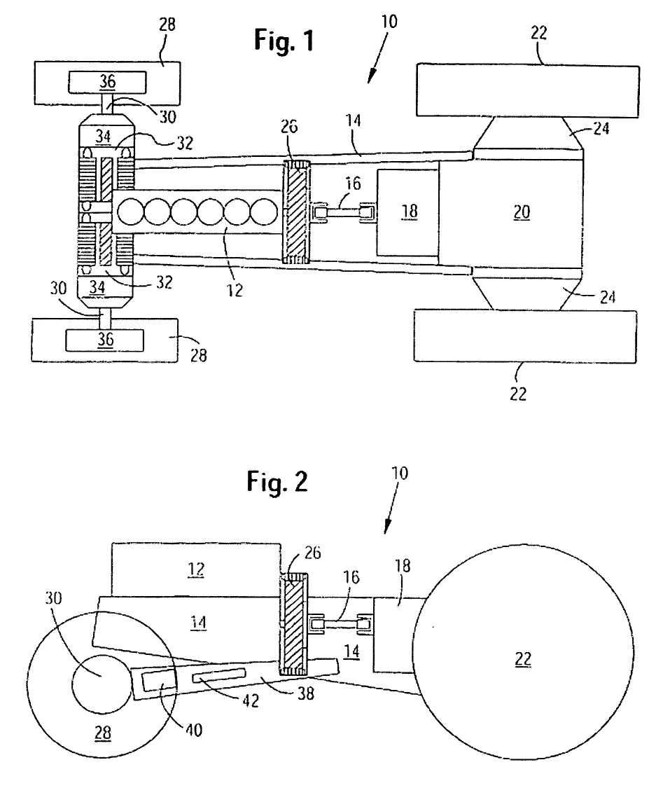

FIG. 1, an embodiment of the present invention in a top view and

FIG. 2, the embodiment from FIG. 1 in a side view.

In FIGS. 1 and 2, an agricultural utility vehicle 10 is shown, wherein identical or similar assemblies are designated with the same reference symbols. The agricultural utility vehicle 10 includes an internal combustion engine 12, which is attached to the frame 14. The internal combustion engine 12 drives the rear wheels 22, which are allocated to the rear axle 24 of the agricultural utility vehicle 10, via the drive shaft 16 and the automatically switched mechanical gear train 18, as well as the differential transmission 20.

The crankshaft generator 26, whose rotor is attached to the drive shaft 16, is arranged around the drive shaft 16. When the internal combustion engine 12 is operating or when the drive shaft 16 rotates, the crankshaft 26 generates electric alternating current at a frequency dependent on the rpm of the internal combustion engine 12. With the electric energy generated by the crankshaft generator 26, the two wheels 28 are driven by the electric motors 32, which are allocated to the vehicle axle 30 and which are embodied in the form of asynchronous motors. The vehicle axle 30 is embodied in the form of a steering-type front axle of the agricultural utility vehicle 10, namely in the form of a rigid axle. Between the electric motors 32 and the wheels 28 there are gear stages 34 and 36, with which the rpm values of the electric motors 32 are reduced.

The vehicle axle 30 is attached to the frame 14 of the agricultural utility vehicle 10 so that it can move, wherein the vehicle axle 30 is suspended so that it can oscillate. For supporting the moving or oscillating suspension, there is a torque tube 38, which is attached with one end to the frame 14 and with its other end to the vehicle axle 30.

According to the invention, electric components 40, 42 for the electric drives 32 are provided on or in the torque tube 38. These electric components 40, 42 include a power electronics assembly 40, to which is allocated a frequency converter and a controller for controlling the electric drives 32 and which is shown in FIG. 2 as one assembly. As other electric components in the torque tube 38, there is braking resistance 42, with which the electric energy generated by an electric drive 32 in generator mode can be converted into heat energy. With this generated heat energy, individual components of the agricultural utility vehicle 10 can be heated, wherein the provided heating lines are not shown for the sake of simplicity.

In conclusion it should be noted in particular that the previously explained embodiments are used merely for describing the claimed teaching, which, however, is not limited to these embodiments.

1. Vehicle axle system for an agricultural or industrial utility vehicle, with a vehicle axle (30)—supported preferably so that it can oscillate—wherein at least two wheels (28) can be attached to the vehicle axle (30) so that they can rotate, with a torque tube (38), which can be connected on one end to a frame (14) of a vehicle (10) and on the other end to the vehicle axle (30) for supporting the axle suspension, and with at least one electric drive (32), which is arranged on the vehicle axle (30) and with which at least one wheel (28) attached to the vehicle axle (30) can be driven, characterized in that there are electric components (40, 42) for the electric drive (32) on—preferably in—the torque tube (38).

2. Vehicle axle system according to claim 1, characterized in that the torque tube (38) has an essentially circular, oval, or polygonal cross section, is preferably assembled from several parts and in particular has a modular configuration.

3. Vehicle axle system according to claim 1 or 2, characterized in that the electric components (40, 42) on the torque tube (38) have at least one power electronics component (40), with which, for example, the magnitude of the electric power that can be delivered to the electric drive (32) can be controlled.

4. Vehicle axle system according to claim 1 or 2, characterized in that at least one power electronics component (40) is arranged on the vehicle axle (30), wherein with the power electronics component (40), for example, the magnitude of the electric power that can be delivered to the electric drive (32) can be controlled.

5. Vehicle axle system according to one of claims 1 to 4, characterized in that the electric components (40, 42) on the torque tube (38) have a frequency converter, with which preferably the electric alternating current of variable frequency that can be generated by an electric generator (26) can be converted first into direct current and then back into alternating current of a given frequency.

6. Vehicle axle system according to one of claims 1 to 5, characterized in that the electric components (40, 42) on the torque tube (38) have braking resistance (42), with which preferably the electric current generated by the electric drive (32) that can be operated in generator mode can be converted into mechanical and/or thermodynamic energy.

7. Vehicle axle system according to one of claims 1 to 6, characterized in that the electric components (40, 42) on the torque tube (38) have a controller, with which preferably the electric drive (32), optionally the power electronics component (40), the frequency converter, and/or the braking resistance (42) can be controlled or regulated.

8. Vehicle axle system according to one of claims 1 to 7, characterized in that the vehicle axle (30) has a steering-type axle and/or is embodied as a front axle.

9. Vehicle axle system according to one of claims 1 to 8, characterized in that on the torque tube (38) there is at least one electric interface, with which at least one electric line on the vehicle frame and/or on the vehicle axle (30) can be connected to at least one electric line on the torque tube (38).

10. Vehicle axle system according to one of claims 1 to 9, characterized in that the electric components (40, 42) on the torque tube (38) can be preassembled in a carrier structure, wherein for final assembly, the carrier structure can be mounted on or in the torque tube (38).

11. Vehicle axle system according to one of claims 1 to 10, characterized in that the surface and/or the walls of the vehicle axle (30) and/or the torque tube (38) is embodied such that cooling of the electric components (40, 42) is possible.

12. Vehicle axle system according to claim 11, characterized in that the surface and/or the walls of the vehicle axle (30) and/or the torque tube (38) has cooling fins and/or at least one channel, wherein the channel preferably has a meander-like arrangement and, in particular, can carry a flow of coolant.

13. Torque tube, which can be connected on one end to a frame (14) of a vehicle (10) and on the other end to a vehicle axle (30) for supporting the axle suspension, characterized in that the torque tube (38) can be attached to a vehicle axle system according to one of claims 1 to 12.

14. Vehicle axle, which can be installed on a vehicle (10) so that it can move and which is supported preferably so that it can oscillate, wherein at least two wheels (28) can be attached to the vehicle axle so that they can rotate, characterized in that the vehicle axle (30) can be adapted to a vehicle axle system according to one of claims 1 to 12.

15. Vehicle, in particular an agricultural or industrial utility vehicle, characterized by a vehicle axle system according to one of claims 1 to 12.
